(19) United States
(12) Patent Application Publication
(10) Pub. No.: US 2017/0291840 A1
(43) Pub. Date: Oct. 12, 2017

(54) APPARATUS FOR PROCESSING GLASS MELT INCLUDING TUBE SEGMENTS JOINED TOGETHER AT AN INTEGRAL SOLID-STATE JOINT AND METHODS

(71) Applicant: Corning Incorporated, Corning, NY (US)

(72) Inventor: Martin Herbert Goller, Campbell, NY (US)

(21) Appl. No.: 15/512,609

(22) PCT Filed: Oct. 1, 2015
(86) PCT No.: PCT/US15/53462

§ 371 Date: Mar. 20, 2017

Related U.S. Application Data
(60) Provisional application No. 62/058,344, filed on Oct. 1, 2014.

(51) Int. Cl. C03B 5/187; C03B 5/167; B01F 3/08; B01F 7/00; B01F 7/18

(52) U.S. Cl. CPC C03B 5/187; B01F 7/00691; B01F 7/007; B01F 7/00908; B01F 7/18; B01F 3/0853; C03B 5/1675; B01F 2003/0892

(57) ABSTRACT

An apparatus for processing a quantity of glass melt comprises a segmented tube including a first tube segment and a second tube segment. A second end portion of the first tube segment is joined to a first end portion of the second tube segment. In further examples, methods of fabricating a segmented torsion tube include joining together segmented torsion tubes at an integral solid-state joint.

This application claims the benefit of priority to U.S. Provisional Application No. 62/058344 filed on Oct. 1, 2014 the content of which is incorporated herein by reference in its entirety.

### BACKGROUND

It is known to process glass melt to produce glass articles with a glass manufacturing apparatus. Conventional glass manufacturing apparatus can include devices fabricated from platinum or platinum alloys to maintain structural integrity under relatively high operating conditions.

### SUMMARY

The following presents a simplified summary of the disclosure to provide a basic understanding of some exemplary aspects described in the detailed description.

The present disclosure relates generally an apparatus for processing a quantity of glass melt and methods of fabricating a segmented tube and, more particularly, to an apparatus including a segmented tube including tube segments that are joined together at a joint and methods of fabricating a segmented torsion tube by joining together segmented torsion tubes at a joint.

In accordance with a first embodiment, an apparatus for processing a quantity of glass melt comprises a glass melt stirring chamber, a segmented torsion tube including a first tube segment comprising a seamless tube fabricated from a first material, a first end portion and a second end portion. The segmented torsion tube further includes a second tube segment comprising a tube fabricated from a second material, a first end portion and a second end portion. The second end portion of the first tube segment is joined to the first end portion of the second tube segment at a joint. The at least one stirring blade mounted to the segmented torsion tube and a motor is configured to apply torque to the first tube segment. In another embodiment, the first material and the second material each comprises platinum alloyed with at least one metal selected from the group consisting of rhodium, iridium, palladium and gold. In yet another embodier material and the second material each comprises an oxide dispersion-strengthened material. In still another embodiment, the apparatus further comprises a sleeve mounting a first stirring blade of the at least one stirring blade to the segmented torsion tube. In a particular embodiment, the sleeve covers the joint. In another embodiment, the joint comprises an integral solid-state joint. In yet another embodiment, the at least one stirring blade comprises a plurality of adjacent stirring blades axially spaced apart along an elongated axis of the segmented torsion tube, wherein the joint is axially positioned between two adjacent stirring blades. In a further embodiment, the second tube segment comprises a seamless tube. In still another embodiment, the first material and the second material each comprises a platinum or a platinum alloy.

In accordance with a second embodiment, a method of processing glass melt comprises the step of stirring a quantity of glass melt within the glass melt stirring chamber with the apparatus of the first embodiment. In one particular embodiment, the joint is submerged below a free surface of the quantity of glass melt within the glass melt stirring chamber during the step of stirring.

In accordance with a third embodiment, an apparatus for processing a quantity of glass melt comprises a segmented tube including a first tube segment comprising a tube fabricated from a first material, a first end portion and a second end portion. The segmented tube further includes a second tube segment comprising a tube fabricated from a second material, a first end portion and a second end portion. The second end portion of the first tube segment is joined to the first end portion of the second tube segment at an integral solid-state joint. In another embodiment, the first material and the second material each comprises a platinum or a platinum alloy. In still another embodiment, the first tube segment, the second tube segment, or both the first tube segment and second tube segment comprises a seamless tube. In yet another embodiment, the integral solid-state joint comprises an integral solid-state welded joint. In a further embodiment, the integral solid-state joint comprises a diffusion-bonded joint. In still a further embodiment, the integral solid-state joint comprises a male/female joint. In another embodiment, the integral solid-state joint comprises a threaded joint.

Of course, the first embodiment, the second embodiment, a embodiment can be provided alone or in combination with one or any combination of the embodiments discussed above.

In accordance with a fourth embodiment, a method of fabricating a stirring apparatus comprises the step (I) of fabricating a segmented torsion tube by joining a second end portion of a first tube segment to a first end portion of a second tube segment with an integral solid-state joint, wherein the first tube segment is fabricated from a first material, the second tube segment is fabricated from a second material. The method further includes the step (II) of mounting at least one stirring blade to the segmented torsion tube. In another embodiment, the first material and the second material each comprises a platinum or a platinum alloy. In yet another embodiment, the first material and the second material each comprises an oxide dispersion-strengthened material. In still another embodiment, the first tube segment, the second tube segment, or both the first tube segment and second tube segment comprises a seamless tube. In yet another embodiment, the step of joining with the integral solid-state joint comprises solid-state welding. In a further embodiment, step (II) comprises mounting a first stirring blade of the at least one stirring blade to the segmented torsion tube with a sleeve. In yet another embodiment, step (II) covers the integral solid state joint with the sleeve. In a further embodiment, the at least one stirring blade comprises a plurality of stirring blades and wherein the method further includes the step of axially positioning the integral solid-state joint between two adjacent stirring blades that are axially spaced apart along an elongated axis of the segmented torsion tube. In another embodiment, the method further comprises the step of positioning the at least one stirring blade within a glass melt stirring chamber of the stirring apparatus. In another embodiment, the method includes the step of coupling a motor to the segmented torsion tube to apply torque to the first tube segment to rotate the stirring blade about an elongated axis of the segmented torsion tube. Of course, the fourth embodiment can be provided alone or in combination with one or any combination of the embodiments discussed above.

Additional features and advantages of the disclosure will be set forth in the detailed description which follows, and in part will be readily apparent to those skilled in the art from that description or recognized by practicing the methods as described herein, including the detailed description which follows, the claims, as well as the ap drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

These and other features, aspects and advantages of the present disclosure can be further understood when read with reference to the accompanying drawings:

FIG. 1 is a schematic view of an apparatus for processing a quantity of glass melt including a glass melt stirring chamber including a segmented torsion tube in accordance with aspects of the present disclosure;

FIG. 2 is an enlarged view of a glass melt stirring chamber taken at view 2 of FIG. 1;

FIG. 3 is an enlarged view of portions of a segmented tube taken at view 3 of FIG. 2;

FIG. 4 is a cross section of the enlarge portions of the segmented tube of FIG. 3 in accordance with one embodiment of the present disclosure;

FIG. 5 is an enlarged view of an integral solid-state joint of the segmented tube taken at view 5 of FIG. 4;

FIG. 6 illustrates tube segments prior to forming a segmented tube with an integral solid-state joint in accordance with embodiments of the disclosure; and

FIG. 7 illustrates tube segments prior to forming another segmented tube with another integral solid-state joint in accordance with embodiments of the disclosure.

### DETAILED DESCRIPTION

Apparatus and methods will now be described more fully her reference to the accompanying drawings in which embodiments of the disclosure are shown. Whenever possible, the same reference numerals are used throughout the drawings to refer to the same or like parts. However, this disclosure may be embodied in many different forms and should not be construed as limited to the embodiments or drawings set forth herein.

Features of the disclosure can provide apparatus for processing a quantity of glass melt. Processing glass melt can form various articles such as glass ribbon, glass tubes, glass vessels, glass fibers or other glass objects. The present disclosure provides a segmented tube comprising a platinum or platinum alloy having sufficient structural integrity under elevated temperature conditions associated with glass melt. In one embodiment, the segmented tube can provide a conduit for glass melt. In another embodiment, the segmented tube can provide a portion of a forming vessel. For instance, the segmented tube can provide a vessel for manufacturing glass tube with the Vello process wherein molten material (e.g., glass melt) is passed through an annular space or an orifice surrounding a hollow pipe or tube having a flow needle/Vello bell which acts as a flow control device and forming device for an exemplary glass tube. In further examples, the segmented tube can facilitate transmission of force (e.g., linear force, rotational force). For example, the segmented tube can help actuate a control valve (e.g., float control valve). In another embodiment, the segmented tube can act to transmit force (e.g., linear force and/or rotational force) to mix or portion glass melt within a mixing/portioning vessel.

Embodiments having a hollow tube can define a travel path for glass melt in applications where the segmented tube acts as a conduit for glass melt. Moreover, the hollow nature of the tube can reduce the amount of expensive platinum or platinum alloy needed to fabricate the tube when compared to solid rod configurations. Furthermore, forming a quantity of platinum or platinum alloy into a tube can provide an increased structural integrity when compared to the same quantity of material formed into a solid rod with a relatively small outside diameter.

The apparatus for processing the quantity of glass melt in some embodiments of the present disclosure can further provide a tube that may be segmented with at least a first tube segment and a second tube segment although any nth segments may be provided in accordance with embodiments of the disclosure. Segmenting the tube can be beneficial for various reasons. For instance, some embodiments include one or more seamless tube segments that are formed from an ingot of material. The seamless nature of the tube provides increased structural integrity since material properties may be carefully controlled to avoid weak points that may otherwise occur with segments including seams. While a single seamless tube may be provided, process limitations when forming the seamless tube can limit the workable ingot size that therefore limits the overall length of the tube. For instance, a tube drawing apparatus may only be able to handle a certain sized ingot that may not have sufficient material to draw the desired length of tubing with the needed tube thickness.

In further examples, segmentation of the tube may allow different tube configurations to reduce the overall amount of expensive platinum or platinum alloy material necessary to produce a tube with the desired length. For instance, different segments of a torsion tube may be customized to handle different torsional force loads based on the intended use of the torsion tube. Tube segments expected to undergo relatively higher torsional loads can be provided with relatively larger diameters and/or relatively higher tube wall thicknesses while tube segments expected to undergo relatively lower torsion loads may be provided with relatively smaller diameters and/or relatively lower tube wall thicknesses. As such, less expensive material may be necessary to fabricate a segmented tube customized to handle different torsional loads along the length of the segmented tube when compared to a single seamless tube designed to handle the maximum torsional load along the entire length of the tube.

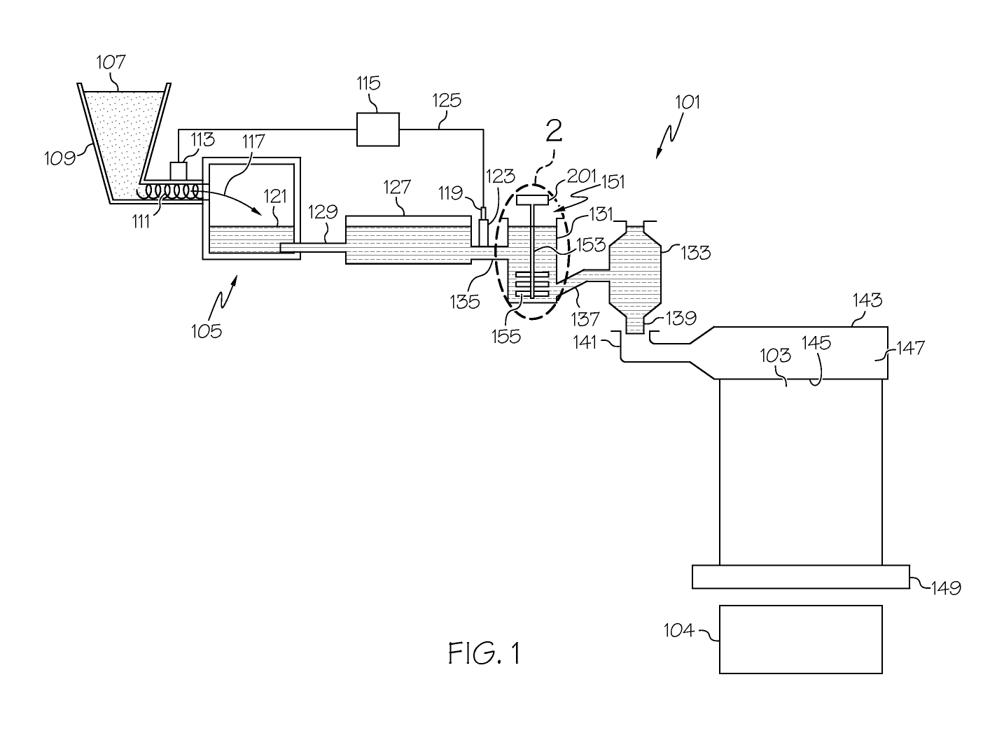

In some examples, the segmented tube may be used in an apparatus for processing a quantity of glass melt comprising a glass manufacturing apparatus configured to fabricate a glass ribbon although other glass processing apparatus may be provided in further embodiments. In some embodiments, the glass manufacturing apparatus can comprise a slot draw apparatus, float bath apparatus, down-draw apparatus, up-draw apparatus, press-rolling apparatus or other glass ribbon manufacturing apparatus. By way of example, FIG. 1 schematically illustrates the apparatus for processing a quantity of glass melt comprising a fusion down-draw apparatus 101 for fusion drawing a glass ribbon 103 for subsequent processing into glass sheets 104. The apparatus 101 can include a melting vessel 105 configured to receive batch material 107 from a storage bin 109. The batch material 107 can be introduced by a batch delivery device 111 powered by a motor 113. An optional controller 115 can be configured to activate the motor 113 to introduce a desired amount of batch material 107 into the melting vessel 105, as indicated by arrow 117. A glass metal probe 119 can be used to measure a glass melt 121 level within a standpipe 123 and communicate the measured information to the controller 115 by way of a communication line 125.

The fusion draw apparatus 101 can also include a first conditioning station such as a fining vessel 127 (e.g., a fining tube), located downstream from the melting vessel 105 and coupled to the melting vessel 105 by way of a first connecting conduit 129. In some examples, glass melt may be gravity fed from the melting vessel 105 to the fining vessel 127 by way of the first connecting conduit 129. For instance, gravity may act to drive the glass melt to pass through an interior pathway of the first connecting conduit 129 from the melting vessel 105 to the fining vessel 127. Within the fining vessel 127, bubbles may be removed from the glass melt by various techniques.

The fusion draw apparatus can further include a second conditioning station such as a glass melt stirring chamber 131 (e.g., a stir chamber) that may be located downstream from the fining vessel 127. The glass melt stirring chamber 131 can be used to provide a homogenous glass melt composition, thereby reducing or eliminating cords of inhomogeneity that may otherwise exist within the fined glass melt exiting the fining vessel. As shown, the fining vessel 127 may be coupled to the glass melt stirring chamber 131 by way of a second connecting conduit 135. In some examples, glass melt may be gravity fed from the fining vessel 127 to the glass melt stirring chamber 131 by way of the second connecting conduit 135. For instance, gravity may act to drive the glass melt to pass through an interior pathway of the second connecting conduit 135 from the fining vessel 127 to the glass melt stirring chamber 131.

The fusion draw apparatus can further include another conditioning station such as a delivery vessel 133 (e.g., a bowl) that may be located downstream from the glass melt stirring chamber 131. The delivery vessel 133 may condition the glass to be fed into a forming device. For instance, the delivery vessel 133 can act as an accumulator and/or flow controller to adjust and provide a consistent flow of glass melt tc vessel. As shown, the glass melt stirring chamber 131 may be coupled to the delivery vessel 133 by way of a third connecting conduit 137. In some examples, glass melt may be gravity fed from the glass melt stirring chamber 131 to the delivery vessel 133 by way of the third connecting conduit 137. For instance, gravity may act to drive the glass melt to pass through an interior pathway of the third connecting conduit 137 from the glass melt stirring chamber 131 to the delivery vessel 133.

As further illustrated, a downcomer 139 can be positioned to deliver glass melt 121 from the delivery vessel 133 to an inlet 141 of a forming vessel 143. The glass ribbon 103 may then be fusion drawn off the root 145 of a forming wedge 147 and subsequently separated into the glass sheets 104 by a separation device 149. As shown, the melting vessel 105, fining vessel 127, the glass melt stirring chamber 131, delivery vessel 133, and forming vessel 143 are examples of glass melt conditioning stations that may be located in series along the fusion draw apparatus 101.

The melting vessel 105 can be made from a refractory material, such as refractory (e.g. ceramic) brick. The fusion draw apparatus 101 may further include components that may be fabricated made from platinum or platinum alloys such as platinum-rhodium, platinum-iridium, platinum-palladium, platinum-gold and combinations thereof, but which may also comprise such refractory metals such as molybdenum, rhenium, tantalum, titanium, tungsten, ruthenium, osmium, zirconium, and alloys thereof and/or zirconium dioxide. In further embodiments, the platinum or platinum alloy components can comprise an oxide dispersion-strengthened material. The platinum-containing components can include one or more of the first connecting conduit 129, the fining vessel 127 (e.g., finer tube), the second connecting conduit 135, the standpipe 123, the glass melt stirring chamber 131 (e.g., a stir chamber) and/or mixing devices (e.g., blades, torsion tubes, etc.), the third connecting conduit 137, the delivery vessel 133 (e.g., a bowl), the downcomer 139 and the inlet 141. The forming vessel 143 may also made from a refractory material and may be designed to form the glass ribbon 103.

Various components of the fusion draw apparatus 101 may include a segmented tube in accordance with aspects of the disclosure. For instance, one or more of the above-referenced platinum-containing components may comprise th, tube in accordance with the disclosure. By way of a non-limiting example, the glass melt stirring chamber 131 can be provided with a glass melt stirring apparatus 151 including a segmented torsion tube 153 and at least one stirring blade 155 mounted to the segmented torsion tube 153.

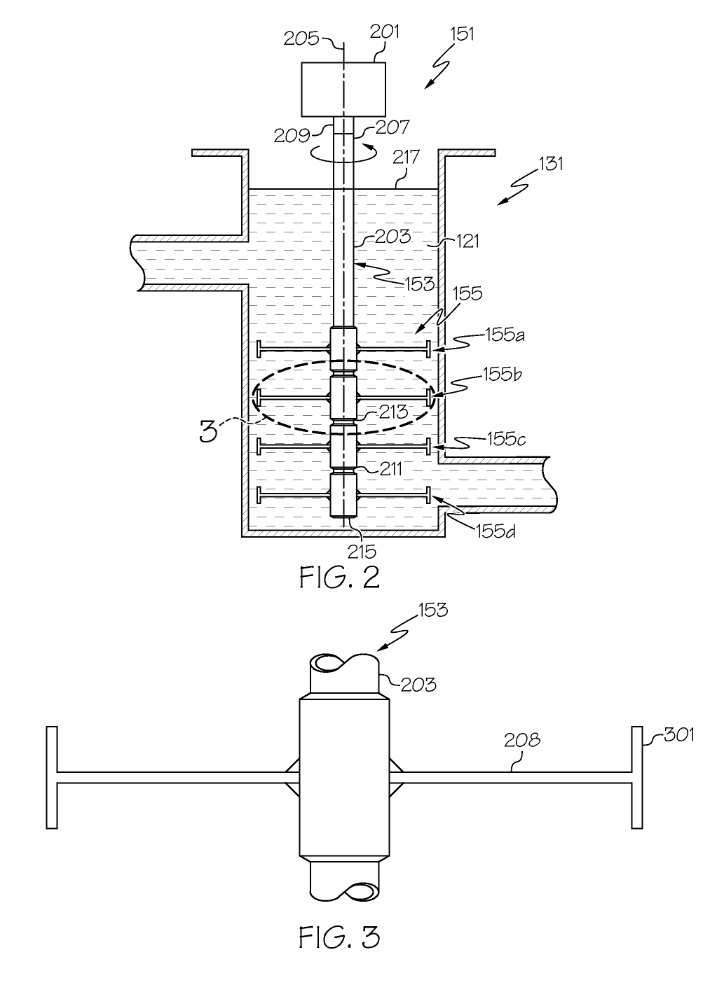

As shown in FIG. 2, the glass melt stirring apparatus 151 can further include a motor 201 configured to apply torque to a first tube segment 203 of the segmented torsion tube 153 such that the motor 201 may be configured to rotate the stirring blade 155 about an elongated axis 205. For instance, as shown, the motor 201 may be coupled to a first end portion 207 of the first tube segment 203 with a coupling mechanism 209 of the motor axially aligned with the first tube segment 203 along the elongated axis 205. As such, in some embodiments, the motor 201 may apply torque to the first end portion 207 of the first tube segment 203 to rotate the stirring blade(s) 155 (155a-155d) about the elongated axis 205 of the segmented torsion tube 153 to stir the quantity of glass melt 121 within the glass melt stirring chamber 131.

As shown in FIG. 3, any one or several of the stirring blades 155 (155a-155d) are schematically illustrated to include an agitating portion 301 and a support member 208. In some examples, the agitating portion 301 may extend the entire length of the support member 208 although the agitating portion 301 can also be mounted to an outer end portion of the support member in further embodiments.

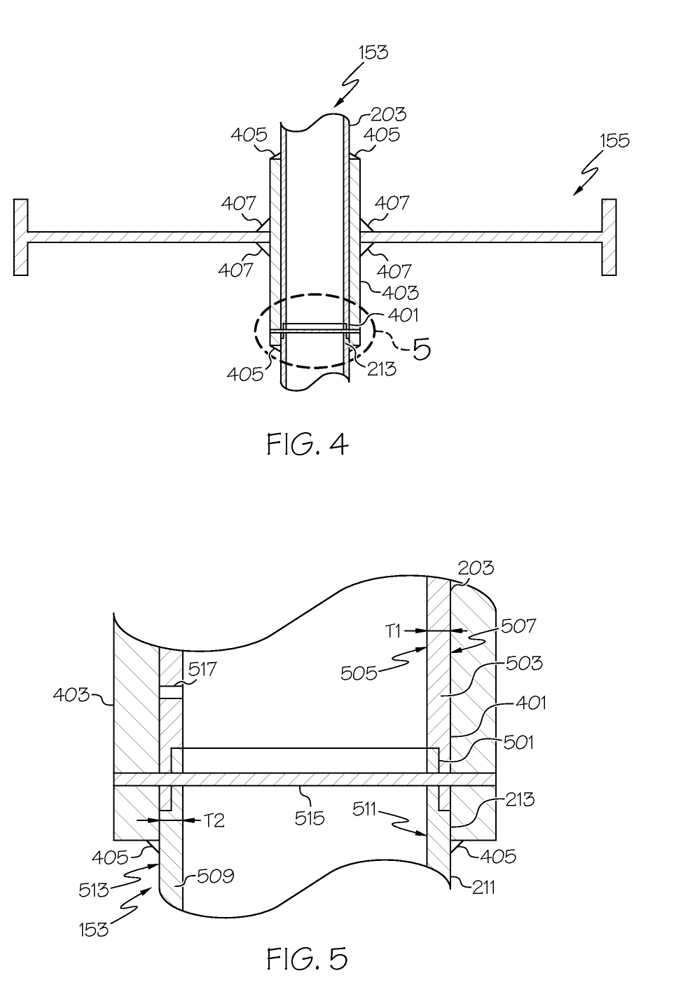

As illustrated in FIGS. 4 and 5, the first tube segment 203 of the segmented torsion tube 153 further includes a second end portion 401. Referring back to FIG. 2, the segmented torsion tube 153 further includes a second tube segment 211 including a first end portion 213 and a second end portion 215. The first tube segment 203 can be fabricated from a first material comprising a platinum or platinum alloy and the second tube segment 211 can be fabricated from a second material comprising a platinum or platinum alloy. The first material and the second material may comprise substantially identical compositions although different compositions are possible in further examples.

The first material of the first tube segment 203 and the second material of the second tube segment 211 can each comprise a platinum or a platinum alloy as discussed above. In some embodiments, the first material and the second each comprise platinum alloyed with at least one metal selected from the group consisting of rhodium, iridium, palladium and gold. Indeed, the first material and the second material may be fabricated from platinum, platinum-rhodium, platinum-iridium, platinum-palladium, platinum-gold and combinations thereof, but which may also comprise such refractory metals such as zirconium, and alloys thereof. In further embodiments, the platinum or platinum alloy components can comprise an oxide dispersion-strengthened material. Providing an oxide dispersion-strengthened material can provide excellent corrosion resistance, creep resistance and mechanical properties at elevated temperatures.

At least the first tube segment 203 and optionally the second tube segment 211 comprises a seamless tube. The seamless tubes may be fabricated with a wide range of techniques. For example, the first tube segment 203 may be fabricated by providing an ingot of the first material with a hole machined (e.g., drilled or punched) from a center of the ingot to form a hollow ingot. The hollow ingot may then be drawn with a drawing apparatus into a tube member with a predetermined wall thickness, internal diameter and external diameter. The first tube segment 203 may then be cut from the tube member with a desired length. As mentioned previously, providing a seamless tube can provide increased structural integrity since material properties may be carefully controlled to avoid weak points that may otherwise occur with segments including seams. As such, a seamless tube may provide enhanced torsional strength and consistency. Thus, the wall thickness may be further reduced while ensuring sufficient torsional strength throughout the entire length of the tube segment. Consequently, a reduced amount of expensive platinum or platinum-alloy may be used to produce a seamless tube with a predetermined length.

In further embodiments, the second tube segment 211 may comprise a seamless tube. As shown in FIG. 2, the relative length of the second tube segment 211 can be significantly shorter than the first tube segment 203. Moreover, the torque loading requirements of the second tube segment 211 may be significantly less than the first tube segment 203. As such, the second tube segment 211 may be formed from a tube including a seam (e.g., weld seam) by a less expensive process. As less material can be used to form a shorter length tube with lower torque loading requirements, material can be weighed when considering the cost benefits achieved with a less expensive tube forming process. However, depending on the design specifications, the second tube segment 211 may also be provided with a seamless tube to provide a reduced amount of expensive platinum or platinum-alloy while providing sufficient torsional strength and consistency along the length of the second tube segment 211.

Still further, as shown, the seamless tube can be provided with a single wall. For instance, as shown in FIG. 5, the first tube segment 203 includes a single, uninterrupted, continuous wall 503 with an inner surface 505 and an outer surface 507 with a wall thickness “T1” extending between the inner surface 505 and the outer surface 507. As further shown in FIG. 5, the second tube segment 211 can likewise include a single, uninterrupted, continuous wall 509 with an inner surface 511 and an outer surface 513 with a wall thickness “T2” extending between the inner surface 511 and the outer surface 513. The single, uninterrupted, continuous wall can avoid trapped air or pockets that might otherwise exist between adjacent walls of a multiple-wall tube construction. Such trapped air or pockets can introduce imperfections that may present weak points in the tube.

In some examples, the wall thickness “T1” of the first tube segment 203 may be substantially identical to the wall thickness “T2” of the second tube segment 211. In further examples, “T1” is not equal to “T2”. For instance, in one embodiment, “T1” can be greater than “T2”. Providing an increased thickness of “T1” can increase the torsional strength of the first tube segment 203 to provide the first tube segment 203 with sufficient torsional strength to carry the load of all the stirring blades. Providing “T2” with a reduced thickness can avoid waste of expensive platinum or platinum alloy material while still providing sufficient strength to carry the load of less than all of the stirring blades. In some examples, “T1” and/or “T2” can have a thickness of from about 1 mm to about 10 mm, such as from about 2 mm to about 7 mm, such as from about 2 mm to about 5 mm, such as from about 2 mm to about 4 mm and all sub-ranges therebetween.

As further shown in FIG. 5, the first tube segment 203 and the second tube segment 211 may have substantially the same inside diameter and substantially the same outside diameter. In further examples, one or both of the inside diameter outside diameter may be different. For instance, the inside diameter and outside diameter of the second tube segment 211 may be smaller than the corresponding inside diameter and outside diameter of the first tube segment 203. Providing the first tube segment 203 with larger inside/outside diameters can provide a tube with sufficient strength to handle a relatively high torsional load. Providing the second tube segment 211 with a relatively smaller inside/outside diameter can provide the tube with a sufficient reduced strength while reducing the amount of expensive materials used to create the second tube segment.

Turning to FIG. 5, the second end portion 401 of the first tube segment 203 may be joined to the first end portion 213 of the second tube segment 211 at an “integral solid-state” joint. The “integral” characteristics of the joint provide a one-piece permanent merger of the second end portion 401 of the first tube segment 203 with the first end portion 213 of the second tube segment 211. The “solid-state” characteristics of the joint involve joining together the respective end portions of the tube segments without melting the materials being joined. Further, the “solid-state” characteristics of the joint provide a joint that does not modify the properties of the material being joined. For example, if the tube segments are formed from an oxide dispersion-strengthened material, the integral solid-state joint can provide a joint without damage to the microstructure of the oxide dispersion-strengthened material that may otherwise occur with conventional joints that melt the material. As such, an exemplary joint can maintain the microstructure of the material at the joint and preserve the beneficial characteristics of the oxide dispersion-strengthened material such as corrosion resistance, creep resistance and mechanical properties at elevated temperatures. In further embodiments, the “solid-state” characteristics of the joint can avoid weak points to a segmented tube that might otherwise occur with other jointing techniques. The integral solid-state joint can provide direct connection between the corresponding ends of the tube segments and can allow the tube segments to integrate together to act as a single segmented tube wherein, for example, a torsion load can be transferred from one tube segment to the other tube segment, partially, substantially or entirely by the integral solid-state joint. In further examples, further joints or features may be applied that may strengthen the joint and such features may further comprise integral solid-state features although the fur may comprise non-integral and/or non-solid-state features.

A method of fabricating the glass melt stirring apparatus 151 therefore can include a step of fabricating the segmented torsion tube 153 by joining the second end portion 401 of the first tube segment 203 with the first end portion 213 of the second tube segment 211 with the integral solid-state joint 501. In one embodiment, the step of joining with the integral solid-stated joint comprises solid-state welding. In one embodiment, the step of solid-state welding can comprise diffusion bonding to provide a diffusion-bonded joint.

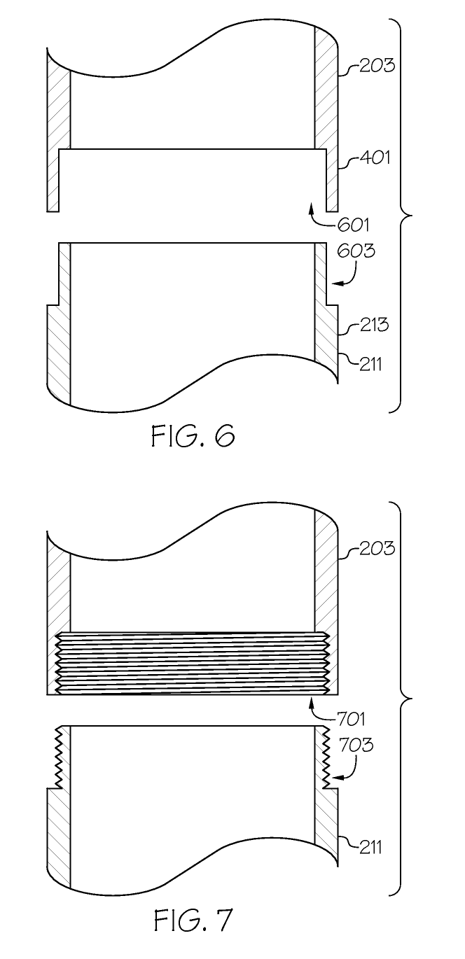

In one embodiment, the integral solid-state joint comprises a male/female joint. Indeed, as shown in FIG. 6, the second end portion 401 of the first tube segment 203 can comprise a female portion 601 configured to receive a male portion 603 of the first end portion 213 of the second tube segment 211. In one embodiment, the method can include press-fitting the male portion 603 into the female portion 601 such that a mechanical interference joint may be provided. The joint can then be placed under elevated temperature where atoms of mated surfaces of the male portion 603 and female portion 601 intermingle to form the integral solid state joint 501. In another embodiment, the method can include heat shrinking the female portion 601 over the male portion 603. The joint can then be placed under elevated temperature where atoms of mated surfaces of the male portion 603 and female portion 601 intermingle to form the integrated solid-state joint 501.

As shown in FIG. 7, the female portion 701 may be threaded with internal threads and the male portion 703 may be threaded with complimentary external threads. In such an example, the method can include threading the male portion 703 into the female portion 703 and applying torque such that the threads are under significant pressure. The joint can then be placed under elevated temperature where atoms of mated surfaces of the male portion 703 and female portion 701 intermingle to form an integral solid-state joint.

In some embodiments, a mounting pin 515 may also extend through the integrated solid state joint 501. For example, the mounting pin 515 may help achieve and maintain a desired interface between the male and female portions prior to integrating the joint together as an integral solid-state joint. For instance, after press-fitting fitting, the mounting pin 515 may be inserted to maintain the orientation before diffusion bonding the joint into an integral solid-state joint.

The method of fabricating the glass melt stirring apparatus 151 can further include the step of mounting the at least one stirring blade 155 to the segmented torsion tube 153. Although not shown, the stirring blade may be directly attached to one of the tube segments without a sleeve. Alternatively, as shown in FIG. 4, the glass melt stirring apparatus 151 may include a sleeve 403 mounting the first stirring blade 155 of the at least one stirring blade to the segmented torsion tube 153. In another embodiment, the sleeve 403 may be provided to cover the integral solid-state joint 501. As such, the sleeve 403 may further increase the structural integrity of the integral solid-state joint 501. As shown, the sleeve 403 may circumscribe the entire outer surface of the segmented torsion tube. Moreover, the sleeve 403 may be welded as indicated by weld seams 405. The weld seams 405 can be carefully controlled to provide very limited depth penetration to the tube segment, thereby minimizing damage and weakness at the weld seams 405. Furthermore, the support member 208 of the stirring blades 155 (155a-155d) can also be welded to the sleeve 403 as indicated by weld seams 407. As shown in FIG. 5, one of the tube segments can include a vent bore 517 configured to release contamination from the welded sleeve to the interior of the segmented torsion tube 153 for subsequent release to the atmosphere.

Turning back to FIG. 2, the at least one stirring blade 155 can comprise a plurality of stirring blades 155a, 155b, 155c, 155d that are axially spaced apart from one another along the elongated axis 205 of the segmented torsion tube 153. Each of the stirring blades 155a, 155b, 155c, 155d may have equal or different spacing therebetween. As shown, the integral solid-state joint 501 (see FIG. 5) can be axially positioned between an axially spaced pair of adjacent stirring blades 155b, 155c although further embodiments may locate the integral solid-state joint between other adjacent pairs of stirring blades (e.g., 155a, 155b; or 155c, 155d in further examples). As such, the length of the first tube segment 203 can be designed to extend a predetermined depth below a free surface 217 of the glass melt 121 such that the joint may be positioned below a stirring blade (e.g., 155b shown in FIG. 2) but not far enough to extend beyond the sleeve 403. In one embodiment, as shown, the joint may be positioned below blade by being positioned below a location where the support member 208 can be attached to the sleeve 403. It should be noted that while sleeves 403 have been illustrated in FIGS. 2-4, the claims appended herewith should not be so limited. In some embodiments, the integral solid-state joint can be strengthened while permitting mounting of the stirring blades to the first tube segment 203 of the second tube segment 211 of the segmented torsion tube 153. As such, the method can include the step of axially positioning the integral solid-state joint between a selected pair of adjacent stirring blades of the at least one stirring blade that are axially spaced apart along an elongated axis of the segmented torsion tube.

As shown in FIG. 2, the method can further include the step of positioning the stirring blade 155 within the glass melt stirring chamber 131 of the glass melt stirring apparatus 151. As further illustrated in FIG. 2, in one embodiment, the integral solid-state joint 501 can be submerged below the free surface 217 of the quantity of glass melt 121 within the glass melt stirring chamber 131 during the step of stirring. The method can further include the step of stirring the quantity of glass melt 121 within the glass melt stirring chamber 131, for example, with the motor 201. Indeed, in one embodiment, the motor 201 can apply torque to the first end portion 207 of the first tube segment 203 to rotate the segmented torsion tube 153 and consequently the stirring blades 155 to stir the glass melt 212 within the stirring chamber.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Likewise, a “plurality” is intended to denote “more than one.”

Ranges can be expressed herein as from “about” one part and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

It will be apparent to those skilled in the art that various modifications and variations can be made to the present disclosure without departing from the spirit and scope of the invention. Thus, it is intended that the present invention cover the modifications and variations of this disclosure provided they come within the scope of the appended claims and their equivalents.

1. An apparatus for processing a quantity of glass melt comprising:
a glass melt stirring chamber;
a segmented torsion tube including a first tube segment comprising a seamless tube fabricated from a first material, a first end portion and a second end portion, the segmented torsion tube further including a second tube segment comprising a tube fabricated from a second material, a first end portion and a second end portion, wherein the second end portion of the first tube segment is joined to the first end portion of the second tube segment at a joint;
at least one stirring blade mounted to the segmented torsion tube; and
a motor configured to apply torque to the first tube segment.

2. The apparatus of claim 1, wherein the first material and the second material each comprises platinum alloyed with at least one metal selected from the group consisting of rhodium, iridium, palladium and gold.

3. The apparatus of claim 1, wherein the first material and the second material each comprises an oxide dispersion-strengthened material.

4. The apparatus of claim 1, further comprising a sleeve mounting a first stirring blade of the at least one stirring blade to the segmented torsion tube.

5. The apparatus of claim 4, wherein the sleeve covers the joint.

6. The apparatus of claim 1, wherein the joint comprises an integral solid-state joint.

7. The apparatus of claim 6, wherein the integral solid-state joint comprises an integral solid-state welded joint.

8. The apparatus of claim 6, wherein the integral solid-state joint comprises a diffusion-bonded joint.

9. The apparatus of claim 6, wherein the integral solid-state joint comprises a male/female joint.

10. The apparatus of claim 6, wherein the integral solid-state joint comprises a threaded joint.

11. The apparatus of claim 1, wherein the at least one stirring blade comprises a plurality of adjacent stirring blades axially spaced apart along an elongated axis of the segmented torsion tube, wherein the joint is axially positioned between two adjacent stirring blades.

12. The apparatus of claim 1, wherein the second tube segment comprises a seamless tube.

13. The method of claim 1, wherein the first material and the second material each comprises a platinum or a platinum alloy.

14. A method of processing glass melt comprising the step of stirring a quantity of glass melt within the glass melt stirring chamber with the apparatus of claim 1.

15. The method of claim 14, wherein the joint is submerged below a free surface of the quantity of glass melt within the glass melt stirring chamber during the step of stirring.

16. An apparatus for processing a quantity of glass melt comprising:
a segmented tube including a first tube segment comprising a tube fabricated from a first material, a first end portion and a second end portion, the segmented tube further including a second tube segment comprising a tube fabricated from a second material, a first end portion and a second end portion, wherein the second end portion of the first tube segment is joined to the first end portion of the second tube segment at an integral solid-state joint.

17. The apparatus of claim 16, wherein the first material and the second material each comprises a platinum or a platinum alloy.

18. The apparatus of claim 16, wherein the first tube segment, the second tube segment, or both the first tube segment and second tube segment comprises a seamless tube.

19. The apparatus of claim 16, wherein the integral solid-state joint comprises an integral solid-state welded joint.

20. The apparatus of claim 16, wherein the integral solid-state joint comprises a diffusion-bonded joint.

21. The apparatus of claim 16, wherein the integral solid-state joint comprises a male/female joint.

22. The apparatus of claim 16, wherein the integral solid-state joint comprises a threaded joint.

23. A method of fabricating a stirring apparatus comprising the steps of:
fabricating a segmented torsion tube by joining a second end portion of a first tube segment to a first end portion of a second tube segment with an integral solid-state joint, wherein the first tube segment is fabricated from a first material, the second tube segment is fabricated from a second material; and
(II) mounting at least one stirring blade to the segmented torsion tube.

24. The method of claim 23, wherein the first material and the second material each comprises a platinum or a platinum alloy.

25. The method of claim 23, wherein the first material and the second material each comprises an oxide dispersion-strengthened material.

26. The method of claim 23, wherein the first tube segment, the second tube segment, or both the first tube segment and second tube segment comprises a seamless tube.

27. The method of claim 23, wherein the step of joining with the integral solid-state joint comprises solid-state welding.

28. The method of claim 23, wherein step (II) comprises mounting a first stirring blade of the at least one stirring blade to the segmented torsion tube with a sleeve.

29. The method of claim 23, wherein step (II) covers the integral solid state joint with the sleeve.

30. The method of claim 23, wherein the at least one stirring blade comprises a plurality of stirring blades and wherein the method further includes the step of axially positioning the integral solid-state joint between two adjacent stirring blades that are axially spaced apart along an elongated axis of the segmented torsion tube.

31. The method of claim 23, further comprising the step of positioning the at least one stirring blade within a glass melt stirring chamber of the stirring apparatus.

32. The method of claim 23, further including the step of coupling a motor to the segmented torsion tube to apply torque to the first tube segment to rotate the stirring blade about an elongated axis of the segmented torsion tube.
